(19) United States
(12) Patent Application Publication
(10) Pub. No.: US 2023/0103400 A1
(43) Pub. Date: Apr. 6, 2023

(54) INTELLIGENT ELECTRONIC FUELING STATION COMPONENT PROVISIONING

(71) Applicant: Wayne Fueling Systems LLC, Austin, TX (US)

(72) Inventors: Hob Hairston, Cedar Park, TX (US); Henry Fieglein, Leander, TX (US); Patrick Keene, Austin, TX (US); Tushar Patil, Austin, TX (US); Dinesh Kumar, McKinney, TX (US)

(21) Appl. No.: 17/937,596

(22) Filed: Oct. 3, 2022

Related U.S. Application Data
(60) Provisional application No. 63/251,778, filed on Oct. 4, 2021.

(51) Int. Cl. G05B 19/416

(52) U.S. Cl. CPC G05B 19/416; G05B 2219/45076

(57) ABSTRACT

System configuration data characterizing a configuration of a fueling station system that includes a fueling station controller and an electronic fueling station component, each located at a fueling station, can be received. Component configuration data characterizing a configuration of the electronic fueling station component can be received. A query can be determined based on the received component configuration data and the received system configuration data. The query can be provided to a remote database, and the remote database can be configured to determine, based on the received query, operation data characterizing data required to operate the fueling station system. The operation data can be received from the remote database. The fueling station controller and the electronic fueling station component can be configured to operate based on the received operation data and the received system configuration data. Related apparatus, systems, methods, techniques, and articles are also described.

### CROSS-REFERENCE TO RELATED APPLICATIONS

This application claims priority under 35 U.S.C. § 119 to U.S. Provisional Patent Application No. 63/251,778, entitled “INTELLIGENT ELECTRONIC FUELING STATION COMPONENT PROVISIONING,” and filed on Oct. 4, 2021. The entire contents of which is hereby expressly incorporated by reference herein.

### FIELD

The current subject matter relates generally to intelligent electronic fueling station component provisioning.

### BACKGROUND

Customers at fueling stations can execute transactions in one of several ways: 1) by interacting with a fuel dispenser; 2) by interacting with a fueling station attendant in markets where self-serve fueling is not allowed; 3) by interacting with a point-of-sale terminal inside the fueling station; and 4) by interacting with the fueling station via mobile devices and/or connected vehicles. Some of the systems and devices in operation at a fueling station, such as electronic fueling station components and a fueling station controller, can include varying operating systems, hardware components, network connections, security restrictions, software versions, executable programs, and the like, such that they may need individualized configuration parameters and operating processes. Indeed, one or more of the components used at fueling stations in executing fueling station transactions can be closed technology solutions that are incompatible with components from multiple manufacturers, encourage vendor lock-in, are inflexible and allow little ability for the store operator to customize their operation and configuration, a consumer's experience with the electronic components, and the brand identities portrayed by the electronics components. As such, there can be limited flexibility for fueling stations to adapt to changing customer and fueling station component technological needs.

### SUMMARY

Methods and systems for intelligent electronic fueling station component provisioning are provided. Related apparatus, systems, techniques, and articles are also described.

In an aspect, system configuration data characterizing a configuration of a fueling station system that includes a fueling station controller and an electronic fueling station component in operable communication with the fueling station controller, each located at a fueling station, can be received. Component configuration data characterizing a configuration of the electronic fueling station component can be received by the fueling station controller and from the electronic fueling station component. A query can be determined by the fueling station controller based on the received component configuration data and the received system configuration data. The query can be provided to a remote database by the fueling station controller, and the remote database can be configured to receive the query and to determine, based on the received query, operation data characterizing data required to operate the fueling station system. The operation data can be received from the remote database by the fueling station controller. The fueling station controller and the electronic fueling station component can be configured to operate based on the received operation data and the received system configuration data.

One or more of the following features can be included in any feasible combination. For example, the system configuration data can include data characterizing a configuration parameter of the fueling station system that permits communication between the electronic fueling station component and the fueling station controller. For example, the component configuration data can include data characterizing a configuration parameter of the electronic fueling station component that permits communication between the electronic fueling station component and the fueling station controller. For example, the electronic fueling station component can include a fuel dispenser. For example, the electronic fueling station component can include at least one sensor configured to determine an identity and a location of a fueling station customer within the fueling station. For example, the electronic fueling station component can include a display configured to depict thereon graphical data, the depicted graphical data based on the determined identity and the determined location of the fueling station customer. For example, the electronic fueling station component can include a point-of-sale terminal. For example, instructions to the fuel dispenser to control operations for the dispensing of fuel from the fuel dispenser can be transmitted by the fueling station controller and based on the received operation data and the received system configuration data.

In another aspect, a system is provided and can include at least one data processor and memory storing instructions configured to cause the at least one data processor to perform operations described herein. The operations can include receiving system configuration data characterizing a configuration of a fueling station system that includes a fueling station controller and an electronic fueling station component in operable communication with the fueling station controller, the fueling station controller and the electronic fueling station component located at a fueling station; receiving, by the fueling station controller and from the electronic fueling station component, component configuration data characterizing a configuration of the electronic fueling station component; determining, by the fueling station controller, a query based on the received component configuration data and the received system configuration data; providing, by the fueling station controller, the query to a remote database, the remote database being configured to determine, based on the received query, operation data characterizing data required to operate the fueling station system; receiving, by the fueling station controller and from the remote database, the operation data; and configuring the fueling station controller and the electronic fueling station component to operate based on the received operation data and the received system configuration data.

One or more of the following features can be included in any feasible combination. For example, the system configuration data can include data characterizing a configuration parameter of the fueling station system that permits communication between the electronic fueling station component and the fueling station controller. For example, the component configuration data can include data characterizing a configuration parameter of the electronic fueling station component that permits communication between the electronic fueling station component and the fueling station controller. For example, the electronic fueling station component can include a fuel dispenser. For example, the electronic fueling station component can include at least one sensor configured to determine an identity and a location of a fueling station customer within the fueling station. For example, the electronic fueling station component can include a display configured to depict thereon graphical data, the depicted graphical data based on the determined identity and the determined location of the fueling station customer. For example, the electronic fueling station component can include a point-of-sale terminal. For example, the operations can include transmitting, by the fueling station controller and based on the received operation data and the received system configuration data, instructions to the fuel dispenser to control operations for the dispensing of fuel from the fuel dispenser.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a process flow diagram illustrating an example process of some implementations of the current subject matter that can provide for intelligent electronic fueling station component provisioning;

FIG. 2 is a schematic view illustrating components of an example system that can provide for intelligent electronic fueling station component provisioning;

FIG. 3 is a data flow diagram illustrating the transfer of data between one or more of the system components illustrated in FIG. 2;

FIG. 4A is a side perspective view of one embodiment of a fuel dispenser;

FIG. 4B is a front perspective view of the fuel dispenser shown in FIG. 4A; and

FIG. 5 is a diagram showing internal components of the fuel dispenser of FIGS. 4A and 4B.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

In general, a system for intelligent electronic fueling station component provisioning, and methods thereof, are provided. A system incorporating the current subject matter can include a fueling station controller, located at a fueling station, that is in operable communication with one or more electronic fueling station components also located at the fueling station. The fueling station controller can receive system and/or electronic fueling station component configuration data and generate a query based on the received data. The fueling station controller can provide the query to a remote database, which can determine operation data that may be needed for successful and/or improved operation of the fueling station controller and/or the electronic fueling station components. The remote database can provide the operation data to the fueling station controller, and the fueling station controller and/or the electronic fueling station components can be configured based on the operation data received by the fueling station controller.

Such a system can allow for improved and/or dynamic updating of electronic fueling station component configuration parameters (e.g., component system settings) and operating processes (e.g., programs executable on an electronic fueling station component) as well as improved and/or dynamic updating of fueling station system configuration parameters (e.g., fueling station management system settings) and operating processes (e.g., programs executable on a fueling station controller).

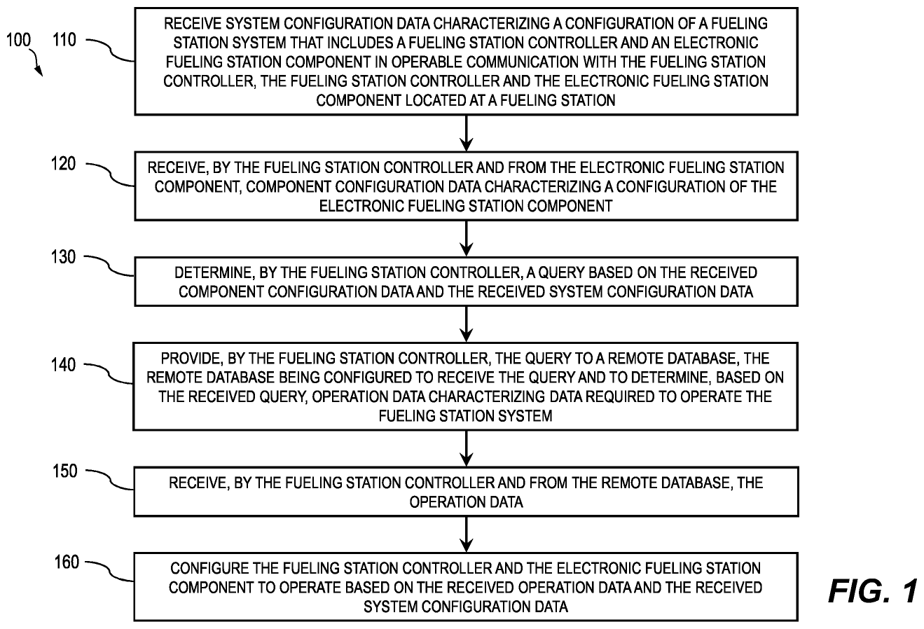

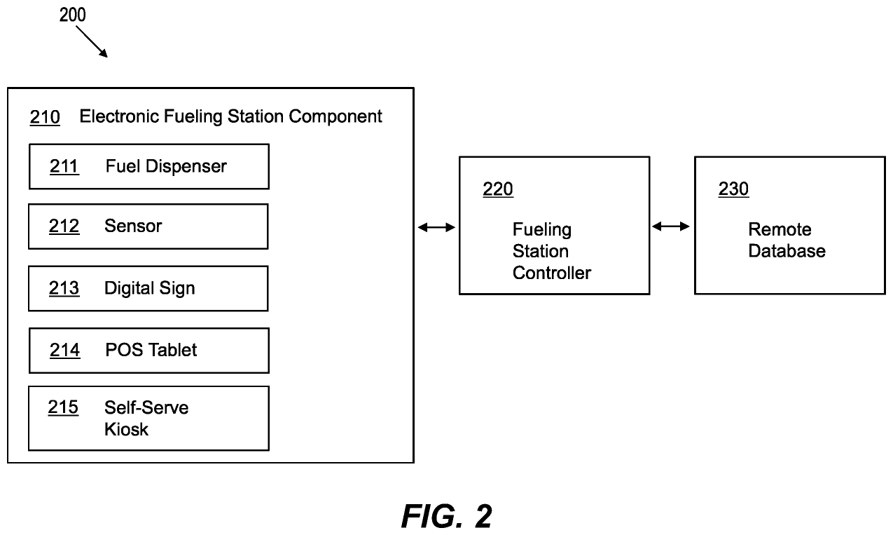

FIG. 1 is a process flow diagram illustrating an example process 100 of some implementations of the current subject matter that can provide for intelligent electronic fueling station component provisioning, and FIG. 2 is a system diagram illustrating an example fueling station system 200 that incorporates some implementations of the current subject matter and that can provide for the same. As shown in FIG. 2, the fueling station system 200 includes an electronic fueling station component 210 that is located at a fueling station and used in the delivery of goods and/or services at the fueling station. In some implementations, for example, the electronic fueling station component 210 is an electronic fuel dispenser 211 that is configured to dispense fuel and having at least one data processor configured to perform the functionality described herein. In some implementations, for example, the electronic fueling station component 210 is a sensor 212 configured to determine an identity and/or a location of a fueling station customer within the fueling station. In some implementations, for example, the electronic fueling station component 210 is a digital sign 213 disposed at the fueling station and that is configured to display various forms of digital media to fueling station customers located at the fueling station. In some implementations, for example, the electronic fueling station component 210 is a point-of-sale (“POS”) tablet 214 that is configured to configured to manage the dispensation of fuel from the fuel dispenser 211 and the transactions occurring at the fueling station, for fuel and non-fuel-related items, and to enable the local management, by a fueling station attendant, of one or more components of the fueling station, including those described elsewhere herein. In some implementations, for example, the electronic fueling station component 210 is a self-serve kiosk 215 that is configured to be used by a fueling station customer to process a transaction occurring at the fueling station without the assistance of a fueling station attendant. In some implementations, the electronic fueling station component 210 can include any combination of the above-described examples of electronic fueling station components, such that the electronic fueling station component 210 includes more than one device and comprises a plurality of electronic fueling station components 210.

In some implementations, the fueling station system 200 can include a fueling station controller 220 that is in operable communication with the electronic fueling station component 210 and that is configured to manage the operation of the components of the system 200; and a remote database 230 in operable communication with the fueling station controller 220 that is configured to provide the fueling station controller with data characterizing operating parameters of the fueling station system 200, as explained in greater detail below. The fueling station controller 220 can contain a memory for storage of instructions for management of the operation of the system 200 and at least one processor for executing those instructions to manage the operation of the system 200. In some implementations, the remote database 230 is a separate component, located externally from the system 200, that is in operable communication with system 200 via the fueling station controller 220.

Referring to both FIGS. 1 and 2, at 110, system configuration data characterizing a configuration of the fueling station system 200 that includes the fueling station controller 220 and the electronic fueling station component 210 can be received. In some implementations, the fueling station controller 220 and/or the electronic fueling station component 210 are located at a fueling station. In some implementations, the system configuration data can be received by the fueling station controller 220. In some implementations, the system configuration data can be generated by the fueling station controller 220 based on one or more forms of information, such as a list of those described elsewhere herein, that are provided to the fueling station controller 220.

In some implementations, wherein the electronic fueling station component 210 includes one or more of the fuel dispenser 211, the sensor 212, the digital sign 213, the POS tablet 214, and the self-serve kiosk 215, the system configuration data can characterize the communication protocols between each of the above-described elements of the electronic fueling station component 210 and the fueling station controller 220. For example, in some implementations, the system configuration data can characterize a communication protocol and/or method between the POS tablet 214 and the fuel dispenser 211 can be configured to execute one or more aspects of a fueling transaction (e.g., dispensing of fuel, processing of transactions). For example, in some implementations, the system configuration data can characterize a communication protocol and/or method between the fuel dispenser 211 and the fueling station controller 220. For example, in some implementations, the system configuration data can characterize a communication protocol and/or method between the fuel dispenser 211 and the remote database 230 and/or other databases that are configured to facilitate the operation of the fuel dispenser 211 and/or other components of the fueling station system 200. For example, in some implementations, the system configuration data can characterize a communication protocol and/or method between the sensor 212 and the fueling station controller 220 and/or the remote database 230 such that the sensor 212 can successfully collect data characterizing the identity and/or location of the fueling station customer within the fueling station and transmit the collected data to the fueling station controller 220 and/or the remote database 230. For example, in some implementations, the system configuration data can characterize a communication protocol and/or method between the digital sign 213 and the fueling station controller 220 and/or the remote database 230 such that communications portrayed on the digital sign 213 are accurately displayed on the digital sign 213 and at the correct time (e.g., such that proof-of-play is established). For example, in some implementations, the system configuration data can characterize a communication protocol and/or method between the POS tablet 214 and the fueling station controller 220 and/or the remote database 230 such that the POS tablet 214 can be configured to execute of one or more aspects of a fueling transaction (e.g., payment for fuel dispensed from the fuel dispenser 211 and/or for goods/services available at the fueling station). For example, in some implementations, the system configuration data can characterize a communication protocol and/or method between the self-serve kiosk 215 and the fueling station controller and/or the remote database 230 such that the self-serve kiosk 215 can be configured to execute one or more aspects of a fueling transaction (e.g., payment for fuel dispensed from the fuel dispenser 211 and/or for goods/services available at the fueling station). For example, in some implementations, the system configuration data can characterize a communication protocol and/or method between the self-serve kiosk 215 and the POS tablet 214 such that the self-serve kiosk 215 can receive instructions for execution of transactions from the POS tablet 214.

For example, in some implementations, the system configuration data can characterize a number of dispensers present at a fueling station and a number of hoses/nozzles installed at each dispenser. For example, in some implementations, the system configuration data can characterize the types of fuel available at the fueling station and the fluid and/or electronic control relationships between one or more tanks disposed at the fueling station.

In some implementations, the system configuration data can characterize a configuration parameter of the fueling station system 200 that permits communication between one or more of the electronic fueling station components 210 and the fueling station controller 220. In some implementations, the system configuration data can characterize one or more operating processes that are incorporated into the fueling station system 200. In some implementations, the system configuration data can characterize one or more operating processes that are not incorporated into the fueling station system 200 but are required to be installed on the fueling station controller 220 for successful operation of the fueling station system 200.

As explained above, in some implementations, the system configuration data can characterize an operating process that is configured to execute one or more aspects of the operation of the fueling station system 200. For example, in some implementations, the operating process characterized by the system configuration data can include a POS/BOS operating process configured to manage and execute point-of-sale operations across one or more components of the fueling station system 200 (including one or more of the electronic fueling station components 210 described above). For example, in some implementations, the operating process characterized by the system configuration data can include a Stock Out operating process configured to manage inventory of goods and/or services available for sale at the fueling station. For example, in some implementations, the operating process characterized by the system configuration data can include a Pricing operating process configured to manage the pricing of goods and/or services available for sale at the fueling station. For example, in some implementations, the operating process characterized by the system configuration data can include a Shopping Cart operating process configured to manage the accumulation of goods and/or services desired for purchase at the fueling station by a fueling station customer across one or more of the types of the electronic fueling station components 210 described above. For example, in some implementations, the operating process characterized by the system configuration data can include a Behavior operating process that is configured to 1) analyze customer behavior data acquired by one or more of the above-described electronic fueling station components 210 and characterizing a history of goods/service purchases made by a fueling station customer and/or a history of a user's browsing of goods/services available for purchase at the fueling station, and 2) determine insights data characterizing patterns of the fueling station customer's behavior from the analyzed customer behavior data. For example, in some implementations, the operating process characterized by the system configuration data can include an Autonomous operating process that is configured to automatically manage one or more aspects of the operation of the fueling station system 200 with limited or no input from a fueling station attendant.

For example, in some implementations, the operating process characterized by the system configuration data can include a Wetstock operating process that is configured to locate and identify instances of fuel loss at the fueling station based on real-time acquired data characterizing an inventory of fuel available for purchase at the fueling station (e.g., data acquired from the one or more of the electronic fueling station components 210 that characterizes fuel purchases at the fueling station, data from a fuel stock sensor (e.g., a tank gauge) configured to measure a level of fuel available for purchase at the fueling station, etc.). For example, in some implementations, the operating process characterized by the system configuration data can include a Pay operating process configured to manage the payment processes for fueling station transactions. For example, in some implementations, the operating process characterized by the system configuration data can include a Monitor operating process that is configured to provide centralized monitoring and management of fuel dispensers and payment modules, to provide remote maintenance access and/or software and firmware updates to one or more of the electronic fueling station components 210, to analyze data acquired by the fueling station controller 220 and/or one or more of the electronic fueling station components 210 characterizing fueling transaction operations and to provide operational insight data characterizing the operations of the fueling station system 200. For example, in some implementations, the operating process characterized by the system configuration data can include a Loyalty operating process that is configured to analyze and manage data characterizing customer loyalty accounts and to analyze and manage one or more aspects of transactions at the fueling station that are associated with the customer loyalty accounts. For example, in some implementations, the operating process characterized by the system configuration data can include a Promote operating process that is configured to analyze customer data acquired by one or more of the electronic fueling station components 210 and/or other external sources and to generate and provide personalized media content (e.g., suggested media, targeted advertisements based on purchase history/predicted interests of the customer, etc.) for display on a display of one or more of the electronic fueling components 210 (e.g., an interactive display of the fuel dispenser 211, a display of the self-serve kiosk 215, the display of the digital sign 213, etc.). For example, in some implementations, the operating process characterized by the system configuration data can include a Control operating process that is configured to control one or more aspects of the operation of the fueling station system 200 and/or components of the fueling station system 200.

In some implementations, one or more of the above-described operating processes can communicate with an external operating module to achieve enhanced functionality of the components of the fueling station 200. For example, in some implementations, the external operating module can include an External Mobile Payment Processor Application (“MPPA”) module that is configured to provide communications between mobile payment applications, token vaults, and site systems (e.g., fuel dispenser 211, POS tablet 214, and/or self-serve kiosk 215) such that a fueling station customer can pay for fuel, goods, and/or services purchased at the fueling station via their mobile device. For example, in some implementations, the external operating module can include a Payment FEPs module that is configured to facilitate the authorization of credit and debit card transactions between the above-described External MPPA module (and/or the above-descripted site systems) and credit card/debit card issuer networks, such that the above-described site systems can settle credit and debit card transactions. For example, in some implementations, the external operating module can include an External Payment Service module that is configured to interface with outside payment systems to secure payment for goods and/or services purchased by the customer at the fueling station. For example, in some implementations, the external operating module can include a Loyalty FEPs module that is configured to interact with the above-described site systems such that they can track and enable the redemption of loyalty points from a fueling station customer's loyalty account(s). For example, in some implementations, the external module can include an External Loyalty Service module that is configured to provide information characterizing outside loyalty programs for use by one or more of the operating processes in generating and providing data characterizing enhanced loyalty rewards for redemption by the customer of the fueling station. For example, in some implementations, the external module can include an Advertising module that is configured to provide data characterizing advertising content for use by one or more of the operating processes in generating and providing data characterizing targeted advertisements to the customer of the fueling station.

At 120, component configuration data characterizing a configuration of the electronic fueling station component 210 can be received by the fueling station controller 220 and from the electronic fueling station component 210. In some implementations, the component configuration data can characterize a configuration parameter of the electronic fueling station components 210 that permits communication between one or more of the above-described electronic fueling station components 210 and the fueling station controller 220. In some implementations, the component configuration data can characterize the parameters of an application that can be executed on one or more of the electronic fueling station components 210. In some implementations, the component configuration data can characterize a listing of client instances of the above-described operating processes that are configured to execute on one or more of the electronic fueling station components 210.

In some implementations, the component configuration data can characterize a listing of software versions of software executable on one or more of the electronic fueling station components 210, firmware versions of firmware executable on one or more of the electronic fueling station components 210, specifications of hardware of one or more of the electronic fueling station components 210, and/or an application stored in a memory of one or more of the electronic fueling station components 210. For example, in some implementations, the component configuration data can characterize one or more available operations of the fuel dispenser 211 that are not directed to the purchase of fuel at the fuel dispenser 211 (e.g. ordering of made-to-order items, browsing and/or shopping for non-fuel products, the purchase of non-fuel products, etc.). For example, in some implementations, the component configuration data can characterize a number of sensors 212 installed at the fueling station, a type of each of the number of sensors 212 installed (e.g., cameras, temperature sensors, proximity sensors, cooler/freezer door sensors, quick serve food heater temperature sensors, etc.), and installed software/configurations of the sensor 212 that permit monitoring of stock-out conditions, improper cooler/freezer/quick serve heater operation at the fueling station, autonomous shopping, and/or the determination of customer behavior analytics using data acquired by the sensor 212. For example, in some implementations, the component configuration data can characterize a number of digital signs 213 present at the fueling station, including a size of the digital signs 213, and whether each of the number of digital signs 213 is interactive or not, and whether they are configured to provide communications to a fueling station customer that are directed to information, shopping, and/or promotions.

At 130, a query characterizing the received component configuration data and the received system configuration data can be determined by the fueling station controller 220. For example, some implementations, the fueling station controller 220 can assess the received component configuration data and the received system configuration data to determine whether there are any discrepancies between the component configuration data and the system configuration data that would require additional software to resolve, and the fueling station controller 220 can determine the query such that it characterizes a request for the additional software needed to resolve the discrepancy. For example, in some implementations, wherein the system configuration data characterizes one or more operating processes that are not incorporated into the fueling station system 200 but are required for successful operation of the fueling station system 200, the fueling station controller 220 can determine, from the system configuration data, which operating processes are required to be installed on the fueling station controller 220 for successful operation of the components of the fueling station system 200. The fueling station controller 220 can determine the query such that it characterizes a request for data characterizing the operating processes that required to be installed for successful operation of the fueling station system 200.

For example, in some implementations, wherein the received component configuration data characterizes one or more applications installed in a memory of one or more of the electronic fueling station components 210, the fueling station controller 220 can assess the installed applications against the operating processes installed or required to be installed in fueling station controller 220 and determine whether an additional application is required to be installed in the memory of one or more of the electronic fueling station components 210 for successful operation of the components 210 in accordance with the received system configuration data. The fueling station controller 220 can determine the query such that it characterizes a request for data characterizing the additional application for installation on the components 210 to effect the successful operation of the components 210 as described above.

For example, in some implementations, wherein the component configuration data characterizes a listing of software versions of software executable on one or more of the electronic fueling station components 210, firmware versions of firmware executable on one or more of the electronic fueling station components 210, and specifications of hardware of one or more of the electronic fueling station components 210, the fueling station controller 220 can assess the component configuration data to analyze any deficiencies in the software and/or firmware of the components 210 that would preclude the components 210 from successfully functioning with the above-described operation processes and/or applications, and the fueling station controller 220 can determine the query such that it characterizes a request for data characterizing the software and/or firmware, for installation on the components 210, that is needed for proper function of the operation processes and/or applications when used in the system 200.

For example, in some implementations, wherein the component configuration data characterizes specifications of hardware of one or more of the electronic fueling station components 210, the fueling station controller 220 can determine the query such that it characterizes a request for data characterizing versions of the above-described operating processes and/or applications that are compatible with the hardware of the components 210. For example, in some implementations wherein the component configuration data characterizes a first configuration parameter for one or more of the electronic fueling station components 210, and wherein the system configuration data characterizes a second configuration parameter for the successful operation of the system 200 and/or the installed/required to be installed operating processes described above, the fueling station controller 220 can assess the first configuration parameter against the second configuration parameter and/or operating processes to determine whether an optimized configuration parameter of the components 210 and/or the controller 220 is required for successful operation of the system 200, and the fueling station controller 200 can determine the query such that it characterizes a request for data characterizing the optimized configuration parameter.

At 140, the query can be provided to the remote database 230 by the fueling station controller 220, and the remote database 230 can be configured to determine, based on the received query, operation data characterizing data required to operate the fueling station system 200. In some implementations, the fueling station controller 220 can enter a mutual authentication process with the remote database 230 such that a secure data connection between the fueling station controller and the remote database 230 is established for transmission of the query to the remote database 230. In some implementations, the operation data determined by the remote database 230 can include the operation processes described above that are required to be installed on the fueling station controller 220 for successful operation of the fueling station system 200. In some implementations, the operation data determined by the remote database 230 can include the above-described applications for execution on the electronic fueling station components 210. In some implementations, the operation data determined by the remote database 230 can include software and/or firmware, for installation on the fueling station controller and/or the electronic fueling station components 210, that enables the successful function of the operation processes and/or applications in the system 200. In some implementations, the operation data determined by the remote database 230 can include an optimized configuration parameter for one or more of the electronic fueling station components 210 and/or for the fueling station controller 220 that enables the improved or successful function of the operation processes, applications, and/or components of the system 200.

At 150, the operation data can be received from the remote database 230 at the fueling station controller 220.

At 160, the fueling station controller 220 and the electronic fueling station component 210 can be configured to operate based on the received operation data and the received system configuration data. For example, in some implementations, wherein the received operation data includes the one or more of the above-described applications for installation and execution on one or more of the electronic fueling station components 210, the fueling station controller 220 can install the application characterized by the received operation data on the one or more electronic fueling station components 210 and in accordance with the system configuration data. In some implementations, the application can be installed by the fueling station controller 220 on the one or more electronic fueling station components 210 and in accordance with the system configuration data. For example, in some implementations, wherein the received operation data includes one or more of the above-described operation processes, the fueling station controller 220 can install the operation process(es) on the memory of the fueling station controller 220 and/or a memory of another component of the system 200. For example, in some implementations, when the received operation data includes an optimized configuration parameter for one or more of the electronic fueling station components 210 and/or for the fueling station controller 220, the fueling station controller 220 can adjust the configuration parameters of one or more of the components 210 and/or the fueling station controller 220 in accordance with the optimized configuration parameter.

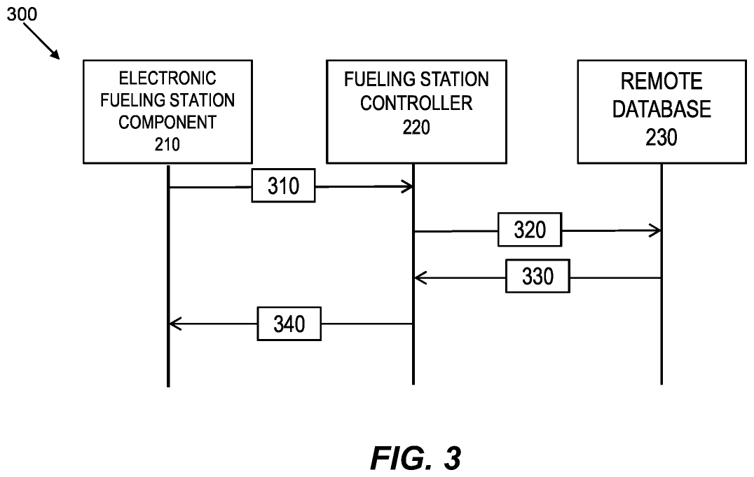

FIG. 3 is a data flow diagram 300 illustrating the transfer of one or more of the types of data described herein between one or more of the system components illustrated in FIG. 2 and in accordance with some implementations of the current subject matter.

In some implementations, one or more of the electronic fueling station components 210 of the fueling station system 200 can, at 310, provide component configuration data, such as the component configuration data described above, to the fueling station controller 220. The fueling station controller 220 can determine a query based on the received component configuration data and, at 320, the fueling station controller 220 can provide the query to the remote database 230. The remote database 230 can determine operation data characterizing data required to operate the fueling station system based on the received query and, at 330, the remote database 230 can transmit the operation data to the fueling station controller 220. Once the fueling station controller 220 has received the operation data, the fueling station controller 220 can be configured to operate based on the received operation data and based on system configuration data characterizing the configuration of the fueling station system 200. At 340, the fueling station controller 220 can transmit configuration instructions to the one or more electronic fueling station components 210 based on the received operation data, such that the one or more electronic fueling station components 210 are configured to successfully function in accordance with the received operation data and/or the system configuration data.

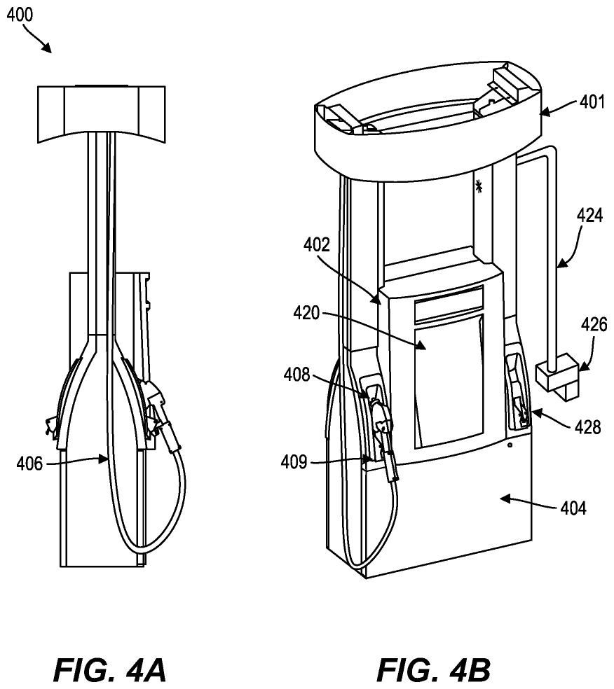

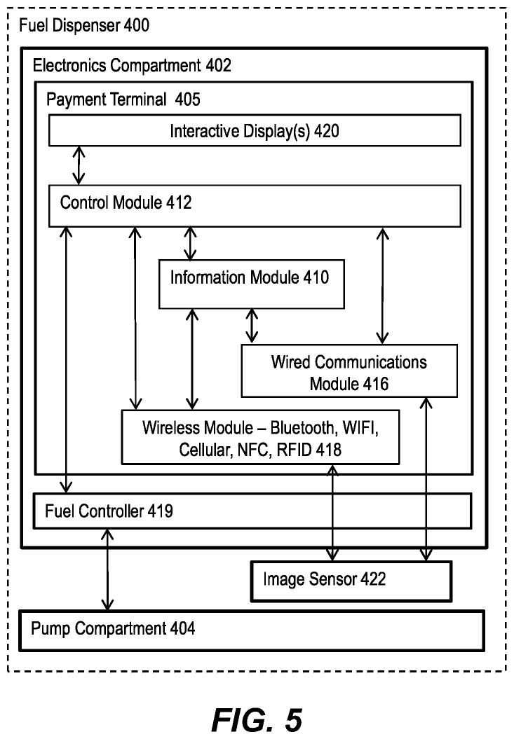

FIGS. 4A and 4B illustrate one embodiment of a fuel dispenser 400 that can be used in some implementations of the current subject matter, and FIG. 5 illustrates components of the fuel dispenser. In general, the dispenser 400 includes a dispenser body 401 having an electronics compartment 402, a pump compartment 404, and an image sensor 422. The pump compartment 404 houses a pump configured to pump fuel from a fuel tank or other reservoir, as well as one or more meters that can be configured to monitor fuel flow, flow of fuel additives, and/or flow of other components of the fuel. The pump compartment 404 can also include other components to facilitate fuel dispensing and mixing, such as motors and valves, a strainer/filtering system, a vapor recovery system, and the like. The pump compartment 404 is isolated from the electronics compartment 402 within the dispenser 400 to facilitate safety, security, and/or maintenance, as will be appreciated by a person skilled in the art. Fuel is thus not allowed to flow from the pump compartment 404 to the electronics compartment 402 and instead flows from the pump compartment 404 through hose 406 to a nozzle 408 for dispensing. As will be appreciated by a person skilled in the art, the nozzles 408 are each configured to dispense fuel from the dispenser 400 as pumped therefrom by the pump. The dispenser 400 also includes a nozzle receptacle 409 configured to store the nozzle 408 when not in use.

In some implementations, the dispenser 400 can be configured to dispense electricity and can include several components for dispensing the electricity. For example, dispenser 400 can include a charging cable 424 coupled to the dispenser body 401 at one end and configured to deliver electricity to a charging connector 426 coupled to an opposite end. The charging connector 426 can be configured to couple to a charging port of a vehicle (not shown) and to deliver the electricity provided by the dispenser 400, via the charging cable 424, to the vehicle when coupled to the charging port. When not in use, the charging connector 426 can be stored in a charger receptacle 428 formed on the dispenser body 401.

The electronics compartment 402 houses electronics for facilitating payment for fuel and for facilitating the dispensing of the fuel. For example, the electronics compartment 402 can include a fuel controller 419 that, at least in some implementations, includes a data processor, memory, and storage forming part of at least one computing system. The fuel controller 419 is configured to control dispensing of the fuel from the pump compartment 304. The electronics compartment 402 also includes a payment terminal 405 that is configured to provide a user with one or more options to create a desired fuel mixture, receive instructions characterizing the desired fuel mixture, receive payment information and/or user identification information from a user, transmit and receive the payment information and/or the user identification information with a POS system via a forecourt controller (not shown), and deliver fueling instructions to the fuel controller 419 to dispense fuel. The payment terminal 405 can also be configured to provide a user with information related to a status of fueling. For example, the payment terminal can display an amount of fuel that has been dispensed, and a corresponding fuel cost as the fuel mixture is dispensed.

The payment terminal 405 can be configured to facilitate communication between a user and the fuel controller 419, and can include an interactive display 420 and an information module 410. The information module 410 can, at least in some implementations include a data processor, memory, and storage, forming part of at least one computing system. The payment terminal 405 can also include one or more wired communication modules 416 and/or wireless communication modules 418 and a control module 412 that, at least in some implementations includes a data processor, memory, and storage, forming part of at least one computing system. The communication modules 416, 418 can function to allow data to be transmitted to and from various components within the payment terminal 405 via wired and/or wireless communication, respectively. For example, the communication modules 416, 418 can be configured to transmit and receive signals that can characterize, e.g., payment information, user identification information, and/or information regarding a desired fuel selection, via wired and/or wireless communications, respectively. The wireless communication module 418 can include, e.g., a transceiver for communicating via Bluetooth protocol, cellular protocol, WI-FI protocol, near field communication (NFC), and/or a radio frequency identification (RFID) protocol. Wired and/or wireless communication via the communication modules 416, 418 can be according to any of a variety of communication protocols, e.g., TCP/IP, etc., as will be appreciated by a person skilled in the art. The communication modules 416, 418 are also in operable communication with the image sensor 422 and are configured to receive image data acquired by the image sensor 422. The communication modules 416, 418 can additionally transmit the received image data for further external processing as described elsewhere herein.

The interactive display 420, which can be, or can include, a touchscreen. The interactive display 420 can be operably coupled to the control module 412 which can be used to control, dynamically rearrange, and/or update a graphical user interface (GUI) rendered on the display 420. The display 420 can be configured to show information (e.g., media content, fuel selection options, payment information, user identification information, etc.) in the form of one or more graphical elements, or graphical objects, receive input (e.g., instructions for a desired fuel mixture, user identification information, payment information, etc.) thereon, and can deliver data characterizing the input to the control module 412 to be processed. Some examples of information that the display 420 can receive from the user are: total cost, desired fuel volume, desired fuel mixture, desired additives, an initiate fueling command, and a terminate fueling command. In some implementations, the user can provide user information, such as user preferences, contact information, etc., and/or information regarding a device that will consume the fuel, such as vehicle make, model, mileage, and the like. The user can also be provided with a recommend fuel blend which they can choose to select.

To facilitate payment, the information module 410 can be configured to receive input such as, e.g., user identification information and/or payment information, and deliver the information to the control module 412. For example, the information module 410 can include a barcode and/or QR code scanner, and/or a NFC contactless card reader for receiving payment information and/or user identification information.

In some embodiments, the information module 410 be operably coupled to the image sensor 422 for acquiring images of facial features of the user, barcode and/or QR code information (e.g., to scan a loyalty rewards card), vehicle features (e.g., vehicle make, model, color, etc.), license plate number, non-facial body features, and the like, which can be used as user identification information. As another example, the information module 410 can include a palm reader and or/fingerprint reader which can scan a palm and/or finger of the user to obtain user identification information. In some embodiments, the user identification information can be associated with a loyalty rewards identifier automatically. Accordingly, in some embodiments, a pre-determined payment method, and user preferences, can be determined based on user identification information.

As shown in FIG. 5, the information module 410 can be operably coupled to the wired communication module 416 and/or the wireless communication module 418. The wired and wireless communication modules 416, 418 can allow the information module 410 to send and receive payment information and/or user identification information to and from a mobile device such as a smart phone, tablet, laptop, and the like, that is in electronic communication with the information module 410 via the wired and/or wireless communication modules 416, 418. Although the wireless communication module 418 is shown to be located within the payment terminal, the wireless communication module 418 can be located elsewhere on, within, or in the vicinity of, the fuel dispenser 400. For example, the wireless communication module 418 can be mounted on top of the fuel dispenser, which can facilitate retrofitting the wireless communication module 418 to existing fuel dispensers and/or facilitate repair, upgrade, or other maintenance of the communication module 418, as described in U.S. patent application Ser. No. 15/182,201 filed on Jun. 14, 2016 and entitled “Methods and Devices for Fuel Dispenser Electronic Communication.”

The subject matter described herein can provide several advantages. For example, the configuration of fueling station systems and components provided by the methods and systems described herein can allow for more efficient and streamlined set up, maintenance, and reconfiguration of existing fueling station systems and fueling station electronic fueling station components, which can enable dynamic and flexible control of fueling station operations and reduce loads on processors of components at fueling stations. In addition, as a result of the subject matter described herein is that the components of the fueling station system are configured to cohesively operate, the subject matter described herein can allow for managed operation of all components of the fueling station system from a single electronic interface, thereby reducing processing and electronic components required for electronic fueling station management. In addition, the subject matter herein allows for the electronic platforms that are used in the operation of the fueling station system to be customized based on the combination of hardware and/or software that is available for use by the fueling station system at a fueling station.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method comprising:
receiving system configuration data characterizing a configuration of a fueling station system that includes a fueling station controller and an electronic fueling station component in operable communication with the fueling station controller, the fueling station controller and the electronic fueling station component located at a fueling station;
receiving, by the fueling station controller and from the electronic fueling station component, component configuration data characterizing a configuration of the electronic fueling station component;
determining, by the fueling station controller, a query based on the received component configuration data and the received system configuration data;
providing, by the fueling station controller, the query to a remote database, the remote database being configured to receive the query and to determine, based on the received query, operation data characterizing data required to operate the fueling station system;
receiving, by the fueling station controller and from the remote database, the operation data; and
configuring the fueling station controller and the electronic fueling station component to operate based on the received operation data and the received system configuration data.

2. The method of claim 1, wherein the system configuration data includes data characterizing a configuration parameter of the fueling station system that permits communication between the electronic fueling station component and the fueling station controller.

3. The method of claim 1, wherein the component configuration data includes data characterizing a configuration parameter of the electronic fueling station component that permits communication between the electronic fueling station component and the fueling station controller.

4. The method of claim 1, wherein the electronic fueling station component includes a fuel dispenser.

5. The method of claim 1, wherein the electronic fueling station component includes at least one sensor configured to determine an identity and a location of a fueling station customer within the fueling station.

6. The method of claim 5, wherein the electronic fueling station component includes a display configured to depict thereon graphical data, the depicted graphical data based on the determined identity and the determined location of the fueling station customer.

7. The method of claim 1, wherein the electronic fueling station component includes a point-of-sale terminal.

8. The method of claim 4, further comprising transmitting, by the fueling station controller and based on the received operation data and the received system configuration data, instructions to the fuel dispenser to control operations for the dispensing of fuel from the fuel dispenser.

9. A system comprising:
at least one data processor; and
memory storing instructions configured to cause the at least one data processor to perform operations comprising:
receiving system configuration data characterizing a configuration of a fueling station system that includes a fueling station controller and an electronic fueling station component in operable communication with the fueling station controller, the fueling station controller and the electronic fueling station component located at a fueling station;
receiving, by the fueling station controller and from the electronic fueling station component, component configuration data characterizing a configuration of the electronic fueling station component;
determining, by the fueling station controller, a query based on the received component configuration data and the received system configuration data;
providing, by the fueling station controller, the query to a remote database, the remote database being configured to determine, based on the received query, operation data characterizing data required to operate the fueling station system;
receiving, by the fueling station controller and from the remote database, the operation data; and
configuring the fueling station controller and the electronic fueling station component to operate based on the received operation data and the received system configuration data.

10. The system of claim 9, wherein the system configuration data includes data characterizing a configuration parameter of the fueling station system that permits communication between the electronic fueling station component and the fueling station controller.

11. The system of claim 9, wherein the component configuration data includes data characterizing a configuration parameter of the electronic fueling station component that permits communication between the electronic fueling station component and the fueling station controller.

12. The system of claim 9, wherein the electronic fueling station component includes a fuel dispenser.

13. The system of claim 9, wherein the electronic fueling station component includes at least one sensor configured to determine an identity and a location of a fueling station customer within the fueling station.

14. The system of claim 13, wherein the electronic fueling station component includes a display configured to depict thereon graphical data, the depicted graphical data based on the determined identity and the determined location of the fueling station customer.

15. The system of claim 9, wherein the electronic fueling station component includes a point-of-sale terminal.

16. The system of claim 12, wherein the operations further comprise transmitting, by the fueling station controller and based on the received operation data and the received system configuration data, instructions to the fuel dispenser to control operations for the dispensing of fuel from the fuel dispenser.

17. A non-transitory computer program product storing instructions which, when executed by at least one data processor forming part of at least one computing system, cause the at least one data processor to implement operations comprising:
receiving system configuration data characterizing a configuration of a fueling station system that includes a fueling station controller and an electronic fueling station component in operable communication with the fueling station controller, the fueling station controller and the electronic fueling station component located at a fueling station;
receiving, by the fueling station controller and from the electronic fueling station component, component configuration data characterizing a configuration of the electronic fueling station component;
determining, by the fueling station controller, a query based on the received component configuration data and the received system configuration data;
providing, by the fueling station controller, the query to a remote database, the remote database being configured to determine, based on the received query, operation data characterizing data required to operate the fueling station system;
receiving, by the fueling station controller and from the remote database, the operation data; and
configuring the fueling station controller and the electronic fueling station component to operate based on the received operation data and the received system configuration data.
